(19) United States
(12) Patent Application Publication
(10) Pub. No.: US 2004/0113774 A1
(43) Pub. Date: Jun. 17, 2004

(54) Personal proximity warning system

(76) Inventor: Dennis Alexander Wilson, Mayfield (AU)

Correspondence Address: WILDMAN, HARROLD, ALLEN & DIXON, 225 WEST WACKER DRIVE, CHICAGO, IL, 60606, US

(21) Appl. No.: 10/451,483

(22) PCT Filed: Dec. 20, 2001
(86) PCT No.: PCT/AU01/01662

(30) Foreign Application Priority Data
Dec. 20, 2000 (AU) PR 2178
Dec. 14, 2001 (AU) PR 9270

(51) Int. Cl. G08B 1/08

(52) U.S. Cl. 340/539.23

(57) ABSTRACT

The present invention relates to an apparatus and method for a proximity warning system that is designed for use in warehouses, wharves, factories, and other industrial sites. The invention provides a proximity warning apparatus for use in warehouses, wharves and other industrial sites, comprising, a first transmitting and receiving means arranged to be mounted to a first body and to a second transmitting and receiving means arranged to be mounted to a second body, wherein the first and second bodies are movable relative to one another, so that they may come into proximity with one another and, wherein the first transmitting and receiving means is arranged to transmit a electromagnetic signal to the second transmitting and receiving means and vice versa, to provide an indication when the first and second bodies are in proximity to each other, or to provide an indication when the second and first bodies are in proximity to each other respectively.

### FIELD OF INVENTION

The present invention relates to an apparatus and method for a proximity warning system that is designed for use in warehouses, wharves, factories, and other industrial sites.

### BACKGROUND OF THE INVENTION

Areas such as warehouses, wharves, and industrial complexes are populated by a mixture of containers, machinery, vehicles, and people.

Since machinery, vehicles and people tend to constantly move around such areas, there is a need to determine who or what occupies a space at any given time, and moreover, whether two objects, be they vehicles and/or people, are likely to collide.

Moreover, for safety reasons, it is imperative that persons proceeding on foot through such areas be prevented from walking into the oncoming path of a vehicle or into a zone where hazardous machinery is operating.

Traditionally, this has been achieved by fitting the vehicles or machinery with either an audible or visible warning mechanism, such as a “beeper” (ie. a device which emits a high pitched beeping sound) and/or a flashing light.

Such warning systems are limited in their effectiveness, for a number of reasons.

Firstly, visible warning signals are only useful when there is a direct line of sight between two objects. In many cases, warehouses have shelving systems that are tightly packed together and similarly, on wharves, containers are stacked in such a way as to maximise the utilisation of available space, which invariably minimises the line of sight between adjacent objects. In such situations, visible warning systems are ineffectual. For example, a person may be facing away from a vehicle, or the person may be situated “around a corner” from a vehicle. The person is unable to see the visible warning, and therefore unable to take evasive action within a reasonable amount of time.

Audible warning systems such as beepers are also limited in their effectiveness. They are commonly fitted to a heavy vehicle such as a forklift, and they rely on another person, whether it is a person proceeding on foot, or another heavy vehicle, to become aware of the beeper and take evasive action as necessary. Machinery or other background noise may muffle the sound that emanates from the beeper, so that a person may not become aware of the presence of another vehicle until there is no reasonable time left to take evasive action.

Therefore, there is a need for an apparatus and or method which allows a vehicle and/or a person proceeding on foot to be aware of the presence of other vehicles and/or persons operating within their immediate vicinity.

### SUMMARY OF THE INVENTION

In a first aspect, the present invention provides proximity warning apparatus for use in warehouses, wharves and other industrial sites, comprising,

a first transmitting and receiving means arranged to be mounted to a first body and a second transmitting and receiving means arranged to be mounted to a second body,

wherein the first and second bodies are movable relative to one another, so that they may come into proximity with one another and,

wherein the first transmitting and receiving means is arranged to transmit an electromagnetic signal to the second transmitting and receiving means and vice versa, to provide an indication when the first and second bodies are in proximity to each other.

Thus, at the first body the proximity of the second body can be detected and/or at the second body the proximity of the first body can be detected.

Preferably, the first transmitting and receiving means is arranged to transmit an electromagnetic signal to a plurality of second transmitting and receiving means arranged to be mounted on a plurality of respective second bodies and vice versa.

Preferably, an embodiment of the present invention provides an indication in the form of an audible or visible alarm.

The alarm may take the form of an audible alarm, such as an electronic “beep” or other appropriate warning sound, and/or the alarm may take the form of a visible alarm, such as a flashing red light.

The indication may also be provided as an operation that affects a first body or a second body. For example, the indication may take the form of a circuit designed to cut power to a motor, or to apply the brakes of a vehicle.

Preferably, the apparatus may be attached to any suitable body. A body may include a piece of stationary machinery, such as a large brake press, or a moveable vehicle such as a forklift or a truck. A suitable body may also include a person, whether they are proceeding on foot, or in some form of personal transport such as an electric cart.

Preferably, an embodiment of the present invention provides both a transmitter and receiver within a single module. Incorporating a transmitting means and a receiving means within a single module allows each module to be uniquely identified. By uniquely identifying each module, a system using such modules may be arranged to produce different indications depending on the body to which the module is attached.

For example, if the body which enters the proximity zone of a heavy machine is a person proceeding on foot, then the module may provide an indication in the form of an audible alarm, whereas if the body which enters the proximity zone of a heavy machine is a vehicle, then the module may produce an indication in the form of a visible alarm.

Generally, the invention preferably provides several benefits. Firstly, it allows each user or operator of a receiving means to be aware of other transmitting means within a proximity zone, so that all parties, whether they be a machine operator or a person proceeding on foot, are aware of the proximity of vehicles or other potentially hazardous objects.

Secondly, the transmitting means may include means arranged to interact directly with a machine or heavy vehicle. For example, the transmitter/receiver module may provide an electrical signal that causes the machine to shut down, or the vehicle to slow down, by applying the vehicles brakes.

Preferably, the signal transmitted by the transmitting means is coded. This may be achieved by any suitable means. For example, the signal may be pulse coded using pulse coding technology. This provides several benefits.

Firstly, by coding the signal, the likelihood of false alarms is decreased greatly, as the receiver will preferably only respond to a predetermined signal, and ignore all spurious and background electromagnetic noise.

Secondly, the likelihood of the transmitting means interfering with other devices that operate in the same frequency range is also reduced, as external devices will not respond to a signal they cannot decode.

Preferably, unique information may be transmitted by each transmitting means. This could allow for the identification of individual transmitting means, which may be useful in certain situations. For example, it may be advantageous to know whether the transmitted signal has emanated from a transmitting means attached to a heavy machine or vehicle, or whether the signal has emanated from a transmitting means worn by a person proceeding on foot, as the action taken by the vehicle and/or person carrying the receiving means will vary according to the nature of the body carrying the transmitting means.

In a second aspect, the present invention provides a method of determining the proximity of relatively movable bodies within an industrial situation, comprising the steps of transmitting an electromagnetic signal from a first body, receiving an electromagnetic signal at a second body from the first body, determining the proximity of the first body from the second body, transmitting an electromagnetic signal from a second body, receiving an electromagnetic signal at a first body from the second body, and determining the proximity of the second body from the first body.

In a third aspect, the present invention provides a method of determining the proximity of relatively movable bodies within an industrial situation, comprising the steps of causing a first body to transmit a first signal, enabling a second body to receive the first signal, wherein the second body determines the proximity of the first body, causing a second body to transmit a second signal, enabling a first body to receive the second signal, wherein the first body determines the proximity of the second body.

### BRIEF DESCRIPTION OF THE DRAWINGS

Features and advantages of the present invention will become apparent from the following description of an embodiment thereof, by way of example only, with reference to the accompanying drawings, in which;

FIG. 1 is an illustration of an apparatus in accordance with an embodiment of the present invention including devices in accordance with an embodiment of the present invention and,

FIG. 2 is a flow chart illustrating a method in accordance with an embodiment of the present invention.

### DESCRIPTION OF PREFERRED EMBODIMENT

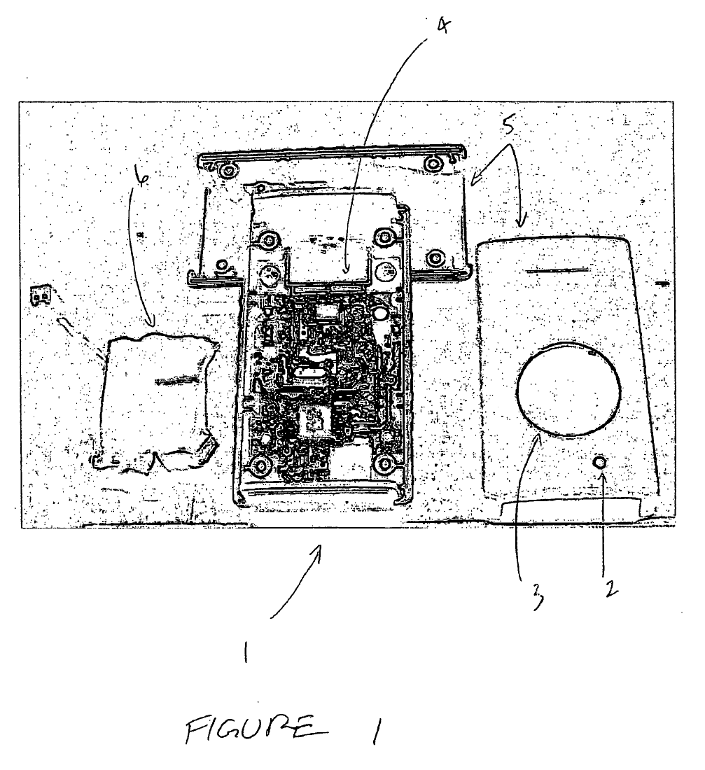

An embodiment of the present invention will now be described with reference to FIG. 1. In FIG. 1, there is shown a first transmitter/receiver module 1, which is arranged to be carried by a person. The transmitter/receiver module may also be arranged to be fitted to a heavy vehicle such as a forklift or a truck, or to a large stationary object, such as a steel cutting guillotine or a brake press. It will be understood that the transmitter/receiver module may be stand-alone (i.e. it may be merely placed on or adjacent to the object), it may be arranged to be fitted permanently or temporarily to the object (by means of a mounting bracket, or other suitable attachment means) or it may be incorporated into the vehicle or machine during the manufacture of the machine or vehicle.

The transmitter/receiver module provides a coded and cycling transmission signal. It is to be understood that the term “coded” within the present context is taken to mean any suitable type of radio signal encoding, such as pulse coding. The coded signal may or may not be encrypted, depending on the needs of the user. The term “cycling” will be understood to mean that the transmitter/receiver module cycles periodically through “send” and “receive” functions. That is, the transmitter/receiver module alternates between a first mode during which the transmitter/receiver module transmits a signal and a second mode during which the transmitter/receiver module receives a signal transmitted by another transmitter/receiver module. In the present embodiment, the coding is provided by a pulse technology modulator, which is controllable in both direction and distance mediums. This allows the transmitter and receiver to be optimised depending on the size and the layout of a site such as a factory, a warehouse, or a wharf. For example, in a warehouse environment, forklifts may be fitted with one transmitter/receiver module, and persons proceeding on foot may be fitted with another transmitter/receiver module. In another example, dangerous machinery in a sheet metal fabrication factory may be fitted with one transmitter/receiver module, and persons working in the vicinity of the machine could be supplied with another transmitter/receiver module, so that a person will be made aware of a possible threat to their safety if they happen to come within a predefined zone surrounding the machine. Each site will have different distance and direction needs, depending on the layout and topography of the site.

A first transmitter/receiver module detects the proximity of another transmitter/receiver module by determining whether a signal from another transmitter/receiver module is received. In other words, the signal strength of all transmitter/receiver modules are purposely limited by their antenna design and power output to extend only to a predefined zone, as required by the topology and layout of a site, and by the safety zone that is required around a particular vehicle or piece of machinery. For most applications, an embodiment of the present invention provides an average of 30 to 40 meters coverage in a forward/backward direction with 10 to 18 meters side coverage. This defines a rectangular zone which is adequate for most applications. However, it is possible to increase or decrease this coverage zone by varying the output power and or antenna size and design, and such modifications are within the contemplation of a person skilled in the art.

In an embodiment of the present invention, the transmitter/receiver module have incorporated several features to monitor signal integrity for situations where there are momentary dropouts or loss of signal.

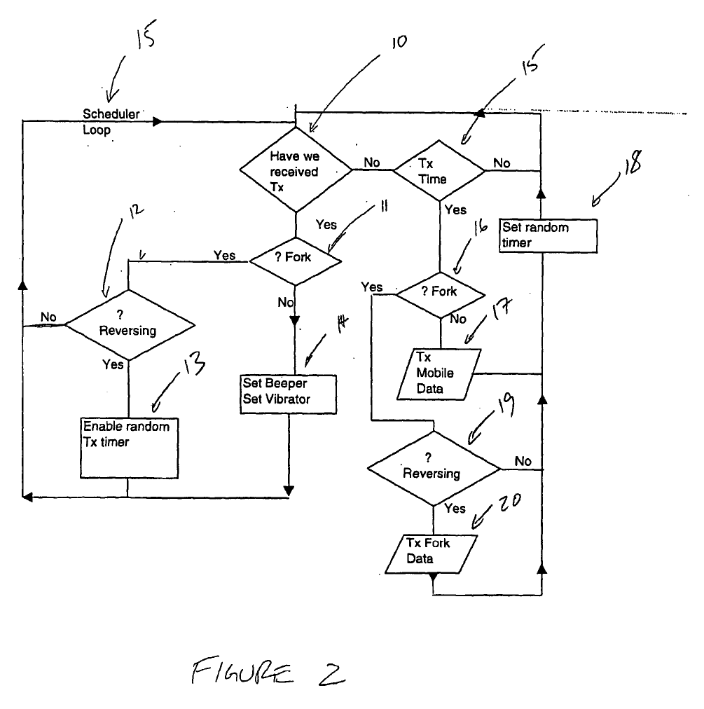

This is shown in FIG. 2, which provides a flow chart in accordance with an embodiment of the present invention. In this simplified embodiment, it is assumed that there are only two types of objects that carry, or are fitted with, the transmitter/receiver modules, namely forklifts and persons proceeding on foot.

The transmitter/receiver module in this embodiment is arranged to be aware of whether it is attached to a person or to a forklift. This may be done by any suitable method. For example, the transmitter/receiver module “type” (i.e. whether the transmitter/receiver module is attached to a forklift or carried by a person) may be hard-wired into the transmitter/receiver module, or it may be changeable by a built-in switching device (e.g. via software, or via a mechanical switch) or by any other suitable means.

In another example, the transmitter/receiver module may be associated with a “base station”, which may act as both a battery re-charger and as a data entry station. When a user collects their transmitter/receiver module after recharging the battery, they may be able to assign their “type” to the module via in-built software.

Moreover, the transmitter/receiver module may be arranged to carry more than rudimentary information. For example, a user may also be able to input a unique identifier, such as their name, allowing them to be uniquely identified by other transmitter/receiver modules. This may be useful in a large number of situations. In one example, the proximity warning system may be arranged to track the whereabouts of all users and carriers of the transmitter/receiver modules. A first user involved in an accident may be able to send a “panic” signal to a second user, and the signal received from the first user may be used to determine the first users identity and location. In another example, if an urgent message must be relayed to a first user, a second user may be able to determine where the first user is situated within a building, and thereby be able to relay the message to the first user.

At the beginning of a cycle, the first transmitter/receiver module determines (10) whether it has received a signal from a second transmitter/receiver module. If a signal has been received from a second transmitter/receiver module, and the first transmitter/receiver module recognises the signal as an appropriately coded signal, then the first transmitter/receiver module performs an internal check (11) to determine whether it is attached to a forklift or carried by a person. If the first transmitter/receiver module is attached to a forklift then the first transmitter/receiver module further checks to see whether the forklift is reversing (12). If the forklift is reversing then the first transmitter/receiver module enables a random timer (13), to create a time gap before returning to step 10. If the first transmitter/receiver module receives a signal (10) and the first transmitter/receiver module is not attached to a forklift, then the first transmitter/receiver module engages a built-in warning light and buzzer (14) to alert the person holding or wearing the first transmitter/receiver module to the close proximity of a forklift. The first transmitter/receiver module then immediately re-checks the proximity of the forklift by returning to step 10 to determine whether the forklift remains within the zone defined by the strength of the transmitted signal.

If the first transmitter/receiver module does not receive a signal (10), it then checks to determine whether it is required to transmit a signal (15) according to an in-built timer. If it is not the correct time to transmit a signal, the first transmitter/receiver module returns to the signal checking mode (10). If it is the correct time to transmit a signal, then the first transmitter/receiver module checks to determine whether it is attached to a forklift (16). If transmitter/receiver module is attached to a forklift, then the transmitter/receiver module checks to determine whether the forklift is reversing (19). If the forklift is reversing, then the transmitter/receiver * module transmits a signal with information to suggest that it is a forklift (20). The transmitter/receiver module then sets the random timer (18) and returns to check whether a signal has been received (10).

If the transmitter/receiver module is attached to a person (16), then the transmitter/receiver module transmits a signal encoded with information to suggest that the transmitter/receiver module is attached to a person (17). The transmitter/receiver module then sets the random timer (18) and returns to the step of checking whether a signal has been received (10).

The transmitter/receiver module is arranged so as to minimise interference from known and unknown sources. This is achieved by the use of coding in the signal. A receiver processing an electromagnetic signal will first determine whether the signal received contains the correct encoding. That is, the transmitter/receiver module has either an electronic hardware or software means for determining whether the format of the signal received by the transmitter/receiver module is in a recognisable format. If the signal received does not match an accepted format or standard of encoding used by the module, the signal will be rejected as a spurious or background noise signal. It is to be understood that the coding may also be changed to suit the site on which an embodiment of this invention is to be applied. For example, if another form of wireless communication is already employed on a site (say, for example, a radio frequency network used for speech communication between workers), then an embodiment of the present invention may be arranged to minimise interference with the radio frequency network already in use at the industrial site. This would be achieved by choosing a coding format which preferably bears little or no resemblance to the format of the radio signals used by the speech communication radio frequency network, or by operating in a frequency range that is different from the radio frequency range. It will be understood that it is within the scope of a person skilled in the art to choose an appropriate coding format, taking into account the special needs of a particular area or industry, as well as local laws and communications standards.

In an embodiment of the present invention, the range of the transmitted signal produced by the transmitter/receiver module would be within the range of 10 metres to 100 metres, although it will be understood that the construction of a transmitter/receiver module with a range of less than 10 metres or greater than 100 metres is within the scope of a person skilled in the art.

Moreover, it is within the scope of an embodiment of the present invention for the transmitter/receiver module is fitted with more than one transmitting or receiving antenna. In some circumstances, it may be necessary to provide more than one antenna for the transmitter/receiver module.

For example, the machine may be very large, such as a large ore carrying truck used in open cut mines, such that one antenna would not be capable of defining an adequate zone around the vehicle. Alternatively, the layout or geography of a site may be such that multiple antennas are required to provide full coverage of the site. For example, at a wharf, stacked containers may define narrow corridors that preclude a single antenna from operating effectively. Furthermore, the height and shape of these container “corridors” may change over time, thereby changing the fundamental layout of the site. In such a situation, transmitter/receiver modules would preferably be fitted with multiple antennas, so that a signal may be propagated efficiently and effectively despite the changing topography of the site.

Moreover, it is within the scope of the present invention to provide a circuit whereby a multi-antenna transmitter/receiver module is aware of which particular antenna is receiving a transmitted signal. This is preferable because at some frequencies, electromagnetic transmissions may be highly directional. In such a situation, the ability to determine which antenna has received the signal will allow an operator and/or the internal electronic circuit is arranged, to determine approximately where the other object or person is located.

In a further embodiment of the present invention, multiple antennes may be installed at fixed locations around a site. When combined with a transmitter/receiver module which is arranged to transmit a unique coded signature, an embodiment of the present invention is able to monitor the location of a number of persons and/or objects within the zones defined by the antennae, and such information may then be conveniently displayed on a computing system or other appropriate hardware at a central location.

Such a system may have many uses, such as tracking whether a person or object is within the defined zone or outside a defined zone. Moreover, the transmitter/receiver module may be combined with a “panic” button, so that a person or machine may be able to alert a central authority of their location and their involvement in a possible hazardous or dangerous incident. It will be understood that such modifications fall within the scope of the present invention.

In another example, this embodiment of the present invention could be used to carry out fire or evacuation checks, to ensure that all persons within a defined site have safely left the site.

Preferably, the transmitter and receiver operate on a frequency range that is “free” (i.e. unrestricted by law or practice) to all users, thereby negating the need for special licences and/or permits to operate the transmitter, as may be required by law. It will be understood that whilst a particular embodiment of the invention may work in the “free” frequency range, it is within the scope of a person skilled in the art to modify the present invention to change the operational frequency of the transmitter/receiver module, so that the transmitter and receiver may operate at any convenient electromagnetic frequency. For example, the circuit may be easily modified to allow the transmitter/receiver module to be used in countries where a different operating frequency range is desired.

It will be understood that the second transmitter/receiver may be adapted to be suitable for any moving object, whether it is a person, another vehicle, or any other object.

The transmitter/receiver module 1 incorporates a warning device, which in the present embodiment takes the form of a visual and audible warning device, namely, a flashing light coupled to a warning buzzer. A first warning light 2 will indicate when the system is out of range. That is, when the transmitter/receiver module is not able to receive a signal from another transmitter/receiver module.

A second light 3 is coupled to a warning buzzer 4. The second light and the warning buzzer will be activated when a predetermined minimum safe distance has been breached. This will warn the user of an impeding danger or collision. As the transmitter/receiver module is physically worn or held by a person or placed prominently within the cabin of a vehicle or near a machine, the likelihood of not becoming aware of the warning (due to a lack of line of sight in the case of visible warnings, or background noise in the case of audible warnings) is greatly reduced.

In an embodiment of the present invention, the casing which houses the transmitter/receiver module is designed and manufactured to withstand harsh environmental conditions as normally found within heavy industry sites. For example, the housings are waterproof to the extent that they will withstand damage from water, rain, hail or snow, as well as other fluids, such as common solvents including petrol, diesel, and other volatile organic chemicals. Moreover, the transmitter/receiver modules are manufactured to withstand temperature extremes, with an effective operating range of −30° C. to +50° C.

It is also within the scope of the present invention to operate the transmitter/receiver module using any suitable power supply technology. Where necessary, the transmitter/receiver module may incorporate an in-built power supply such as a rechargeable battery 6, to allow the transmitter/receiver module to be portable, and allow their use in locations where conventional power supplies are not available, such as in open cut mines, tunnels, etc.

In another example, where the transmitter is arranged to be attached to a stationary machine, such as a steel cutting guillotine, the transmitter/receiver module may be arranged to operate from a suitable power outlet, such as a household or industry standard (240V or 415V) power supply. Any such modification is considered to be within the scope of a person skilled in the art.

Further modifications and variations as would be apparent to a skilled addressee are deemed to be within the scope of the present invention.

The claims defining the invention are as follows:

1. A proximity warning apparatus for use in warehouses, wharves and other industrial sites, comprising,
a first transmitting and receiving means arranged to be mounted to a first body and a second transmitting and receiving means arranged to be mounted to a second body,
wherein the first and second bodies are movable relative to one another, so that they may come into proximity with one another and,
wherein the first transmitting and receiving means is arranged to transmit an electromagnetic signal to the second transmitting and receiving means and vice versa, to provide an indication when the first and second bodies are in proximity to each other.

2. A proximity warning system in accordance with claim 1, wherein the first transmitting and receiving means is arranged to transmit an electromagnetic signal to a plurality of second transmitting and receiving means arranged to be mounted on a plurality of respective second bodies and vice versa.

3. A system in accordance with claim 1 or claim 2 wherein the proximity warning system cycles between transmitting an electromagnetic signal and receiving an electromagnetic signal.

4. A system in accordance with claims 1, 2 or 3 wherein the transmitted signal is coded.

5. An apparatus in accordance with any of the above-referenced claims, wherein the transmitted signal contains information.

6. An apparatus in accordance with claim 5, wherein the information is in the form of a alphanumeric string.

7. An apparatus in accordance with any of the above-referenced claims, wherein the transmitting and receiving means on the second body emits a warning signal dependent on the proximity of the transmitter on the first body.

8. An apparatus in accordance with claims 4, 5, 6 or 7, wherein the coded signal is arranged so that interference with other electromagnetic sources is minimised.

9. An apparatus in accordance with any of the above-referenced claims, wherein the frequency of the electromagnetic signal emitted is within a public frequency band.

10. An apparatus in accordance with any of the above-referenced claims, wherein the frequency is changeable.

11. An apparatus in accordance with any of the above-referenced claims, wherein the signal strength is changeable.

12. An apparatus in accordance with any of the above-referenced claims, wherein at least one antenna is provided.

13. An apparatus in accordance with any of the above-referenced claims, wherein the apparatus is portable.

14. An apparatus in accordance with any of the above-referenced claims, wherein the apparatus may be used with different power sources.

15. An apparatus in accordance with any of the above-referenced claims, wherein the transmitter/receiver module emits a suitable command or instruction to other equipment.

16. A method of determining the proximity of relatively movable bodies within an industrial situation, comprising the steps of transmitting an electromagnetic signal to a first body, receiving an electromagnetic signal at a second body from the first body, determining the proximity of the first body from the second body.

17. A method of determining the proximity of relatively movable bodies within an industrial situation, comprising the steps of causing a first body to transmit a first signal, enabling a second body to receive the first signal, wherein the second body determines the proximity of the first body, and vice versa.
